(19) United States
(12) Patent Application Publication
(10) Pub. No.: US 2004/0086444 A1
(43) Pub. Date: May 6, 2004

(54) Production of metal chalcogenide nanoparticles

(76) Inventor: Mark Green, Oxford (GB)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/415,269

(22) PCT Filed: Oct. 18, 2001
(86) PCT No.: PCT/GB01/04635

(30) Foreign Application Priority Data
Oct. 27, 2000 (GB) 0026382.2

(51) Int. Cl. C01B 19/04

(52) U.S. Cl. 423/266; 423/509

(57) ABSTRACT

A process for preparing a capped metal sulfide, selenide or telluride nanoparticle containing one or a mixture of metals; which process comprises contacting, in an inert organic solvent and in the presence of a polar Lewis base capping ligand, a source of the metal(s) and a source of sulfur, selenium or tellurium, wherein the capping ligand and the source of the metal(s) are soluble in said inert organic solvent. Trialkylphosphine oxide capped mercury sulfide, selenide or telluride nanoparticles may be produced by the process of the invention and are useful as amplifiers in optical cables.

### FIELD OF THE INVENTION

The present invention relates to a new process for the production of capped metal chalcogenide nanoparticles and to new, trialkylphosphine oxide capped mercury chalcogenide nanoparticles.

### BACKGROUND OF THE INVENTION

Nanoparticles of semiconductor materials have recently become of increasing interest due to their differing properties from their bulk material counterparts. These nanoparticles are of particular interest in the fields of non-linear optics and opto-electronics and they have potential applications as amplifiers in optical cables.

Mercury telluride, HgTe, together with the other mercury chalcogenides, is one of the compounds of particular interest. Bulk HgTe is a semi-metal, but with the onset of quantization effects, discrete energy levels appear. This results in an effective widening of the band gap and alters the properties of the substance to that of a narrow band gap semiconductor when nanocrystalline sizes are reached. Despite the potential value of nanocrystalline mercury chalcogenides in the opto-electronics field, the synthetic routes towards these substances are still unsatisfactory.

In a method described by Brennan et al (Chem. Mater., 1990, 2, 403) small HgTe nanoparticles are prepared by photolysis of the single source precursor Hg(TeBu)₂ in pyridine. However, the preparation of the precursor is a difficult and potentially hazardous procedure. Further, the particles produced, although pyridine soluble, are short-lived since they have a tendency to grow into the bulk phase in solution.

A more recent method has been described by Rogach et al (Adv. Mater., 1999, 11, 552). This route involves the growth of thioglycol-capped particles in water by alteration of growth kinetics using pH. Methods based on pH mediated growth in aqueous solution have the disadvantages of potential oxygen doping and of poor size distribution of the nanoparticles produced when compared with analogous nanoparticle syntheses in organic media.

Further methods which have been described include reacting mercury oxide with tellurium powder directly in ethylenediamine to produce cubic HgTe (Ding et al, Chem. Journal Chinese Univ., 2000, 21(3), 344) and the reaction of mercury iodide with sodium telluride in methanol (Mullenborn et al Appl. Phys. A., 1993, 56, 317).

Each of the previously described methods for synthesising nanoparticles of mercury chalcogenides provides nanoparticles in the solid state, or, at best, nanoparticles which are soluble in water or temporarily soluble in pyridine. There is however a desire for lypophilic nanoparticles which can be manipulated in organic media.

Murray et al (J. Am. Chem. Soc., 1993, 115, 8706) describe a synthesis of cadmium chalcogenides which results in tri-n-octylphosphine/tri-n-octylphosphine oxide capped, organically soluble cadmium nanoparticles. However, this method is not of general applicability for metal chalcogenides; for example it is not suitable for use with mercury chalcogenides. A known problem with the production of mercury chalcogenide nanoparticles relates to the rapid and uncontrolled growth of the particles. This leads generally to the formation of large nanocrystals or to bulk material unless the conditions are very carefully controlled. The reaction described by Murray et al is carried out using tri-n-octylphosphine and tri-n-octylphosphine oxide as a solvent, these compounds also acting as the coordinating ligands. Since tri-n-octylphosphine oxide is a solid at room temperature, the reaction must be carried out at elevated temperatures, typically around 100 to 350° C. At these temperatures HgTe synthesis, for example, would result almost entirely in the production of bulk material and would not provide the desired yields of nanoparticulate product.

Thus there is a need for a new method of synthesizing nanocrystalline mercury chalcogenides which provides the product in an organically soluble form. It is also desirable that the method overcomes the further problems associated with the known methods. In particular, the method should preferably be one which is safe and convenient to carry out and which provides high yields of small nanoparticles which remain stable in colloid form for an increased period of time.

### SUMMARY OF THE INVENTION

Surprisingly, we have found a new process which is suitable for the production of nanocrystalline mercury chalcogenides. This method can be carried out in solution at room temperature and therefore addresses the problems associated with the rapid growth of mercury chalcogenide nanoparticles. The nanocrystals can be produced in high yield and are notable for their small size. Further, the process yields almost entirely nanocrystalline product rather than bulk material and is therefore highly favourable.

The new process can be used to produce any nanocrystalline metal chalcogenides, but is particularly valuable for the synthesis of nanoparticles such as the mercury chalcogenides where rapid growth inhibits the production of small nanocrystals.

The process of the invention has also led to the production of new mercury chalcogenide nanocrystals which are capped with trialkylphosphine oxide ligands. The presence of the trialkylphosphine oxide ligands renders the nanoparticles lypophilic, and therefore soluble in organic media. The ligand is also essential as a stabilising agent, for the prevention of conglomeration and for ensuring the electronic stability of the nanocrystal to which it is attached.

These novel nanoparticles are generally stable in organic media for a period of days, allowing increased freedom with regard to their manipulation when compared with previously known mercury chalcogenide nanocrystals.

Accordingly, the present invention provides a process for preparing a capped metal sulfide, selenide or telluride nanoparticle, containing one or a mixture of metals; which process comprises contacting, in an inert organic solvent and in the presence of a polar Lewis base capping ligand, a source of the metal(s), and a source of sulfur, selenium or tellurium; wherein the capping ligand and the source of the metal(s) are soluble in said inert organic solvent.

The present invention also provides a capped metal sulfide, selenide or telluride nanoparticle containing one or a mixture of metals, wherein the capping ligand is a polar Lewis base, which nanoparticle is obtainable, or obtained, by the process of the present invention. The invention filer provides a P(R³)₃O capped mercury sulfide, selenide or telluride nanoparticle, wherein each R³, which may be identical or different, is selected from hydrogen, C₁₋₂₄ alkyl groups, C₂₋₁₄alkenyl groups, alkoxy groups of formula —O(C₁₋₂₄ alkyl), aryl groups and heterocyclic groups, with the proviso that at least one group R³ in each molecule is other than hydrogen.

The invention also provides the use of a capped metal sulfide, selenide or telluride nanoparticle according to the invention as an amplifier in optical cables.

### DETAILED DESCRIPTION OF THE INVENTION

### Synthesis of Metal Chalcogenide Nanoparticles

The invention provides a process which enables nanocrystalline mercury chalcogenides to be synthesized and which is also suitable for the synthesis of other nanocrystalline metal chalcogenides, in particular nanomaterials which form rapidly and which can be problematic to produce in the form of small nanocrystalline units. The synthesis involves contacting, in the presence of an inert organic solvent and a polar Lewis base capping ligand, a source of the desired metal M and a source of the chalcogenide E. The reaction is generally carried out at a temperature of not exceeding 50° C.

The reaction may, for example, be carried out by dissolving the capping ligand and the source of metal M in the inert organic solvent, followed by injecting, or otherwise adding, the source of chalcogenide E in order to initiate the reaction. Alternatively, the capping ligand and the source of chalcogenide E may be dissolved in the inert organic solvent and the reaction initiated by adding the source of metal M. It is preferred that the chalcogenide source is injected into the solution of the metal source and the inert, organic solvent. This order of addition is particularly preferred when M contains In, Ga or Al, since these metals are thought to form a complex with the polar Lewis base prior to reaction. The reaction is desirably carried out under an inert atmosphere such as nitrogen.

The metal component may be one or a mixture of metals which form salts with chalcogenide anions. Typically, the metal is selected from those which form semiconductor materials when combined with a chalcogenide anion e.g. group II-VI, IV-VI or III-VI semi-conductors. Examples of typical metals include Cd, Zn, Hg, In, Ga, Mg, Al, Pt, Pd, Pb, Sn and Bi, preferably Cd, Zn, Ga, In, Hg and Pb. A particularly preferred metal is Hg.

Suitable sources of the metals include salts that are stable in organic media. Typical salts include those with anions, A, such as NO₃⁻, Cl⁻, Br⁻, F⁻, C₂O₄²⁻, CN⁻ and SCN⁻, or with organic groups R¹. Suitable organic groups R¹ include C₁₋₂₄ alkyl groups, preferably C₁₋₄ alkyl groups, C₂₋₂₄ alkenyl groups, preferably C₂₋₄ alkenyl groups, alkoxide groups of formula —O(C₁₋₂₄alkyl), preferably —O(C₁₋₄alkyl), carboxyl groups of formula (C₁₋₂₄alkyl)COO—, preferably (C₁₋₄ alkyl)COO— such as acetate, acetylacetenato (CH₃COCH═C(O—)CH₃), aryl groups and heterocyclic groups.

The metal source may also be a compound MR¹ₐA_{b}, wherein R¹ and A are as defined above and a and b are each 0, 1, 2, 3 or 4 with the proviso that a+b/c, wherein c is equal to the charge on anion A, is equal to the oxidation state of the metal.

Suitable sources of Hg include Hg(NO₃)₂, HgCl₂, HgBr₂, HgF₂, HgC₂O₄, Hg(CH₃CO₂)₂, Hg(CN)₂, Hg(SCN)₂, Hg(OMe)₂, Hg(OEt)₂, Hg(OC(CH₃)═CHCOCH₃)₂, HgMe₂, HgEt₂, HgPh₂, HgMeCl, HgEtCl and HgPhCl. A particularly preferred source of Hg is Hg(CH₃CO₂)₂.

The semiconductor nanoparticles produced by this method may optionally contain more than one of the metals listed above. Typically, such compounds contain two metals which generally have the same oxidation state, for example two metals selected from Cd, Zn and Hg or from Al, Ga and In. Examples of such mixed metal semiconductors include CdₓHg₁₋ₓE, wherein x is from 0 to 1 and E is sulfur, selenium or tellurium.

As used herein, a C₁₋₂₄alkyl group is a linear or branched alkyl group which may be unsubstituted or substituted at any position and which may contain heteroatoms selected from P, N, O and S. Typically, it is unsubstituted or carries one or two substituents. Suitable substituents include halogen, hydroxyl, cyano, —NR₂, nitro, oxo, —CO₂R, —SOR and —SO₂R wherein each R may be identical or different and is selected from hydrogen or C₁₋₄alkyl.

As used herein a C₁₋₄alkyl group is an alkyl group as defined above which contains from 1 to 4 carbon atoms. C₁₋₄ alkyl groups include methyl, ethyl, i-propyl, n-propyl, n-butyl and tert-butyl.

As used herein, a C₂₋₂₄ alkenyl group is a linear or branched alkenyl group which may be unsubstituted or substituted at any position and which may contain heteroatoms selected from P, N, O and S. Typically, it is unsubstituted or caries one or two substituents. Suitable substituents include halogen, hydroxyl, cyano, —NR₂, nitro, oxo, —CO₂R, —SOR and —SO₂R wherein each R may be identical or different and is selected from hydrogen or C₁₋₄alkyl.

As used herein, a C₂₋₄ alkenyl group is an alkenyl group as defined above which contains from 2 to 4 carbon atoms. C₂₋₄alkenyl groups include ethenyl, propenyl and butenyl.

As used herein an aryl group is typically a C₆₋₁₀ aryl group such as phenyl or naphthyl, preferably phenyl. An aryl group may be unsubstituted or substituted at any position, with one or more substituents. Typically, it is unsubstituted or carries one or two substituents. Suitable substituents include C₁₋₄ alkyl, C₁₋₄ alkenyl, each of which may be substituted by one or more halogens, halogen, hydroxyl, cyano, —NR₂, nitro, oxo, —CO₂R, —SOR and —SO₂R wherein each R may be identical or different and is selected from hydrogen and C₁₋₄alkyl.

As used herein a heterocyclic group is a 5- to 10-membered ring containing one or more heteroatoms selected from N, O and S. Typical examples include pyridyl, pyrazinyl, pyrimidinyl, pyridazinyl, furanyl, thienyl, pyrazolidinyl, pyrrolyl and pyrazolyl groups. A heterocyclic group may be substituted or unsubstituted at any position, with one or more substituents. Typically, a heterocyclic group is unsubstituted or substituted by one or two substituents. Suitable substituents include C₁₋₄ alkyl, C₁₋₄ alkenyl, each of which may be substituted by one or more halogens, halogen, hydroxyl, cyano, —NR₂, nitro, oxo, —CO₂R, —SOR and —SO₂R wherein each R may be identical or different and is selected from hydrogen and C₁₋₄alkyl.

As used herein, halogen is fluorine, chlorine, bromine or iodine, preferably fluorine, chlorine or bromine.

The chalcogenide E is selected from S, Se and Te. Suitable sources of chalcogenide include P(R²)₃E, BHE, B₂E, E(R²)₂ and (Si(R²)₃)₂E, wherein B is an alkali metal such as sodium or potassium; and the groups R², which maybe identical or different, are selected from hydrogen, C₁₋₂₄ alkyl groups, C₂₋₂₄ alkenyl groups, alkoxy groups of formula —O(C₁₋₂₄ alkyl), aryl groups and heterocyclic groups. Preferably, R² is selected from hydrogen, C₁₋₁₆ alkyl groups such as C₁₋₄ alkyl groups or hexyl, octyl, nonyl, decyl or dodecyl, C₂₋₄ alkenyl groups, —O(C₁₋₄ alkyl) groups and phenyl. Typical examples of C₁₋₂₄ and C₁₋₄ alkyl groups, C₂₋₂₄ and C₂₋₄ alkenyl groups, aryl groups and heterocyclic groups are described above.

Particular examples of chalcogenide sources include EH₂, NaHE, Na₂E, E(Me)₂, E(Et)₂, E(Ph)₂, E(n-octyl)₂, E(SMe₃)₂, E(SiPh₃)₂, E(Si(tert-Bu)₃)₂, EP(n-octyl)₃ and EP(n-octyl)₃O. Preferred sources of chalcogenide include tri-n-octylphosphine sulfide, tri-n-octylphosphine selenide and tri-n-octylphosphine telluride.

The metal and the chalcogenide may be provided in the form of a single source, for example, a compound MₐE_{b}. Alternatively, the metal and the chalcogenide may be provide in the form of two separate sources.

The molar ratio of M and E (M:E) present in the reaction mixture is typically from 0.8:1 to 1.2:1, preferably from 0.9:1 to 1.1:1, more preferably about 1:1. The amount of metal source and chalcogenide source added is not vital as long as the molar ratio of M:E is approximately as described above.

The polar Lewis base capping ligand may be any suitable compound having an electron-donating group. It may be a volatile or non-volatile ligand, for example a non-volatile ligand. Typical polar Lewis bases include trialkylphosphine oxides P(R¹)₃O, trialkylphosphines P(R³)₃, amines N(R³)₃, thiocompounds S(R³)₂ and carboxylic acids or esters R³COOR⁴ and mixtures thereof, wherein each R³, which may be identical or different, is selected from hydrogen, C₁₋₂₄alkyl groups, C₂₋₂₄ alkenyl groups, alkoxy groups of formula —O(C₁₋₂₄ alkyl), aryl groups and heterocyclic groups, with the proviso that at least one group R³ in each molecule is other than hydrogen; and wherein R⁴ is selected from hydrogen and C₁₋₂₄ alkyl groups, preferably hydrogen and C₁₋₄ alkyl groups. Typical examples of C₁₋₂₄ and C₁₋₄ alkyl groups, C₂₋₂₄ alkenyl groups, aryl groups and heterocyclic groups are described above.

It is also possible to use as the polar Lewis base capping ligand a polymer, including dendrimers, containing an electron rich group such as a polymer containing one or more of the moieties P(R³)₃O, P(R³)₃, N(R³)₃, S(³)₂ or R³COOR⁴ wherein R³ and R⁴ are as defined above; or a mixture of Lewis bases such as a mixture of two or more of the compounds or polymers mentioned above.

The groups R³ are preferably selected from hydrogen, C₆₋₁₆ alkyl groups such as C₈₋₁₂ alkyl groups, C₆₋₁₆ alkenyl groups such as C₈₋₁₂ alkenyl groups, and phenyl. Typical C₈₋₁₂ alkyl groups include octyl, nonyl, decyl and dodecyl, for example straight-chain groups such as n-octyl, n-nonyl, n-decyl and n-dodecyl. Typical C₈₋₁₂alkenyl groups include octenyl, nonenyl and decenyl.

Preferably, the polar Lewis base capping ligand is a group P(R³)₃O or P(R³)₃, in particular a group P(R³)₃O. Particularly preferred Lewis bases are tri-n-octylphosphine (TOP) and tri-n-octylphosphine oxide (TOPO), particularly preferably TOPO.

The capping ligand is capable of stabilising the nanocrystals. The crystals are believed to be drawn towards each other by van der waals attractive forces and, without the capping ligands, the nanocrystals would combine, forming larger nanocrystals and eventually bulk material. The capping ligands however provide a steric barrier to such conglomeration of nanocrystals and therefore increase the stability of the nanocrystals in solution. The capping ligand further aids in electronically stabilising the nanoparticles by blocking the surface sites of the nanocrystal which may act as electron traps.

The capping ligand is generally added in excess, in relation to the amount of metal. Typically, the capping ligand is added in an amount of 1.2 moles or greater per mole of metal preferably 1.5 moles or greater, more preferably 2 moles or greater per mole of metal. It is particularly preferred that the capping ligand is added in as high an amount as possible whilst maintaining solubility, in order to ensure surface passivation of the metal chalcogenide nanoparticles formed.

The inert organic solvent is a solvent which takes substantially no part in the reaction itself. The solvent may be any organic solvent in which the capping ligand and the source of the metal(s) are both soluble. Suitable organic solvents include alcohols, more particularly aliphatic alcohols such as ethanol, propanol such as propan-2-ol and butanol, preferably propan-2-ol and butanol.

The process of the invention is particularly advantageous in that it is carried out in an inert organic solvent rather than in a solution of the coordinating ligand itself. The requirements regarding the temperature at which the reaction is carried out are therefore less stringent and, in particular, elevated temperatures are not required. Typically, the reaction is carried out at a temperature of not exceeding 50° C.; preferably at most 40° C., more preferably at most 30° C. and most preferably at a temperature of from 18 to 25° C. (room temperature). The temperature may however be varied if other factors are determinative. When the nanocrystals to be formed are rapidly growing crystals such as the mercury chalcogenides, lower temperatures such as room temperature are desirable in order that growth can be controlled and high yields of nanoparticulate product are obtained.

The reaction is preferably continued for at least 30 minutes after contacting the metal source and the chalcogenide source in order to provide a good yield of nanoparticles. Preferably, the reaction is continued for at least 1 hour and especially for at least 2 hours.

The nanoparticles produced by the process of the invention generally have a diameter not exceeding 100 nm, preferably not exceeding 20 nm, more preferably 15 nm, 10 nm, 8 nm or 5 nm.

The process of the invention provides a solution of nanoparticulate metal chalcogenide in the organic solvent used. If desired, the product can be directly dispersed in the desired organic solvent. Alternatively, the reaction solvent can be removed by a suitable method, for example by evaporation, to leave the product as a solid. This solid can then be dispersed in the desired organic solvent. Either method may provide a colloid which is relatively stable. For example, a dispersion of TOPO-capped HgTe in toluene which has been produced by the method of the invention has been found to be stable for a period of days.

### Capped Mercury Chalcogenide Nanocrystals

The invention provides HgE nanoparticles which are capped with trialkylphosphine oxide, P(R³)₃O, capping ligands. The chalcogenide E is selected from sulfur, selenium and tellurium, preferably tellurium and each R³, which may be identical or different, is as defined above. Typically, the trialkylphosphine oxide ligand is tri-n-octyl-phosphine oxide (TOPO).

The ligand acts as a stabilising agent both sterically and electronically in the manner described above. The nanocrystals of the present invention are therefore typically stable as colloids in organic solvent systems for at least 12 hours, preferably at least 24 hours, more preferably at least 48 hours.

The nanoparticles of the invention generally have a diameter not exceeding 100 nm, preferably not exceeding 15 nm, more preferably at most 10 nm. The most preferred nanoparticles have a diameter not exceeding 8 nm, e.g. from 2 to 8 nm, in particular about 5 nm.

In summary, the present invention provides a convenient method by which high yields of organically soluble capped mercury chalcogenide nanocrystals can be obtained. The process of the invention is also suitable for the production of other nanocrystalline chalocogenides, in particular where rapid growth of crystals is problematic. The process of the invention allows new, trialkylphosphine oxide capped nanocrystals of the mercury chalcogenides to be produced. These nanocrystals, together with other nanocrystalline semiconductors produced by the process of the invention, are useful in the opto-electronics field, in particular as amplifiers in optical cables.

The invention is described in more detail below with reference to the Example.

### EXAMPLES

### Example 1

### Preparation of HgTe Nanoparticles

Tri-n-octylphosphine oxide (TOPO) (3.50 g, 9.0×10⁻³ M) and mercury (II) acetate (0.49 g, 1.53×10⁻³ M) were added to 100 ml propan-2-ol and stirred until dissolved. N₂ was bubbled through the solution for 40 minutes and the reaction vessel was then attached to a Schlenk line. 1M Tri-n-octylphosphine telluride solution (1.6 ml, 1.6×10⁻³ M) was injected into the reaction mixture and the mixture was stirred at room temperature for 2.5 hours. The mixture was then centrifuged, yielding an optically clear, brown solution of nanoparticulate, TOPO-capped HgTe and a dark brown solid which was disposed of. The propan-2-ol solution is then either reduced in vacuo to leave a dark solid or directly dispersed in toluene. The dark solid may be redispersed in propan-2-ol or dispersed in toluene. The resulting HgTe colloid is stable for several days.

1. A process for preparing a capped metal sulfide, selenide or telluride nanoparticle, containing one or a mixture of metals; which process comprises contacting, in an inert organic solvent and in the presence of a polar Lewis base capping ligand, a source of the metal(s), and a source of sulfur, selenium or tellurium; wherein the capping ligand and the source of the metal(s) are soluble in said inert organic solvent.

2. A process according to claim 1, wherein the nanoparticle contains one or a mixture of metals selected from Cd, Zn, Ga, In, Hg and Pb.

3. A process according to claim 2, wherein the nanoparticle is capped mercury sulfide, selenide or telluride.

4. A process according to any one of the preceding claims, wherein the capping ligand is selected from P(R³)₃O, P(R³)₃, N(R³)₃, S(R³)₂ and R³COOR⁴ and mixtures thereof; wherein each R³, which may be identical or different, is selected from hydrogen, C₁₋₂₄ alkyl groups, C₂₋₂₄ alkenyl groups, alkoxy groups of formula —O(C₁₋₂₄ alkyl), aryl groups and heterocyclic groups, with the proviso that at least one group R³ in each molecule is other than hydrogen; and wherein R⁴ is selected from hydrogen and C₁₋₂₄ alkyl groups.

5. A process according to claim 4, wherein the capping ligand is P(R³)₃O, P(R³)₃ or a mixture thereof wherein R³ is as defined in claim 4.

6. A process according to claim 5, wherein the capping ligand is tri-n-octylphosphine oxide.

7. A process according to any one of the preceding claims, which is carried out at a temperature of not exceeding 50° C.

8. A process according to claim 7, which is carried out at a temperature of from 18 to 25° C.

9. A process according to any one of the preceding claims, wherein the organic solvent is an aliphatic alcohol.

10. A capped metal sulfide, selenide or telluride nanoparticle as defined in any one of claims 1 to 6, which nanoparticle is obtainable by the process of any one of claims 1 to 9.

11. A capped metal sulfide, selenide or telluride nanoparticle as defined in any one of claims 1 to 6, which nanoparticle is obtained by the process of any one of claims 1 to 9.

12. A P(R³)₃O capped mercury sulfide, selenide or telluride nanoparticle, wherein each R³, which may be identical or different, is as defined in claim 4 or claim 6.

13. A nanoparticle according to claim 12, having an average diameter not exceeding 8 nm.

14. A nanoparticle according to claim 12 or claim 13, which is P(R³)₃O capped mercury telluride.

15. Use of a capped metal sulfide, selenide or telluride nanoparticle according to any one of claims 10 to 14 as an amplifier in optical cables.
